(19) United States
(12) Patent Application Publication
(10) Pub. No.: US 2023/0399258 A1
(43) Pub. Date: Dec. 14, 2023

(54) TOUGHENED GLASS PLATE, METHOD FOR MANUFACTURING TOUGHENED GLASS PLATE, AND GLASS PLATE TO BE TOUGHENED

(71) Applicant: Nippon Electric Glass Co., Ltd., Shiga (JP)

(72) Inventor: Ken YUKl, Shiga (JP)

(21) Appl. No.: 18/033,472

(22) PCT Filed: Oct. 7, 2021
(86) PCT No.: PCT/JP2021/037138

§ 371 Date: Apr. 24, 2023

(30) Foreign Application Priority Data
Nov. 9, 2020 (JP) 2020-186608
Mar. 8, 2021 (JP) 2021-036303

(51) Int. Cl. C03C 21/00; C03C 3/11

(52) U.S. Cl. CPC C03C 21/002; C03C 3/11; C03B 17/064

(57) ABSTRACT

The present tempered glass sheet includes a compression stress layer on the surface and a glass composition containing from 40 to 80 mol % of SiO₂, from 6 to 25 mol % of Al₂O₃, from 0 to 10 mol % of B₂O₃, from 3 to 15 mol % of Li₂O, from 1 to 21 mol % of Na₂O, from 0 to 10 mol % of K₂O, from 0 to 10 mol % of MgO, from 0 to 10 mol % of ZnO, from 0 to 15 mol % of P₂O₅, and from 0.001 to 0.30 mol % of SnO₂, in which ([Li₂O]+[Na₂O]+[K₂O])/[Al₂O₃] is greater than or equal to 0.86, and ([SiO₂]+[B₂O₃]+[P₂O₅])/((100×[SnO₂])×([Al₂O₃]+[Li₂O]+[Na₂O]+[K₂O]+[MgO]+[CaO]+[SrO]+[BaO]+[ZnO])) is greater than or equal to 0.40.

### TECHNICAL FIELD

The present invention relates to a tempered glass sheet, a method of manufacturing a tempered glass sheet, and a glass sheet to be tempered. In particular, the present invention relates to a tempered glass sheet suitable as a cover glass for a touch panel display, such as that of a mobile phone, a digital camera, or a personal digital assistant (PDA), a method of manufacturing a tempered glass sheet, and a glass sheet to be tempered.

### BACKGROUND ART

An ion-exchange treated tempered glass sheet is used as a cover glass for a touch panel display, such as that of a mobile phone, a digital camera, or a personal digital assistant (PDA) (see Patent Document 1 and Non-Patent Document 1).

### CITATION LIST

### Patent Literature

Patent Document 1: JP 2006-083045 A
Patent Document 2: JP 2016-524581 T
Patent Document 3: JP 2011-510903 T

### Non-Patent Literature

Non-Patent Document 1: Tetsuro Izumitani et al., “New Glass and Physical Properties Thereof”, First edition, Management System Laboratory. Co., Ltd., Aug. 20, 1984, p. 451-498

### SUMMARY OF INVENTION

### Technical Problem

When a smart phone is accidentally dropped on the pavement or the like, the cover glass may be damaged, and the smart phone may become dysfunctional. In order to avoid such a situation, it is important to increase the strength of the tempered glass sheet.

Increasing depth of layer is an effective method of increasing the strength of the tempered glass sheet. Specifically, if the cover glass collides with the pavement when a smart phone is dropped, protrusions or sand grains on the pavement penetrate into the cover glass and reach a tensile stress layer, leading to the damage of the cover glass. In view of the foregoing, when the depth of layer of a compression stress layer is increased, protrusions or sand grains on the pavement are less likely to reach the tensile stress layer, and thus the probability of cover glass damage can be reduced.

Lithium aluminosilicate glass is advantageous in achieving a large depth of layer. In particular, when a glass sheet to be tempered formed of lithium aluminosilicate glass is immersed in a molten salt containing NaNO₃, Li ions in the glass exchange with Na ions in the molten salt, resulting in a tempered glass sheet having a large depth of layer.

However, in the known lithium aluminosilicate glass, the compression stress value of the compression stress layer may be too small. Meanwhile, when a glass composition is designed to give the compression stress layer an increased compression stress value, chemical stability may decrease.

Furthermore, the known lithium aluminosilicate glass has insufficient clarity, and bubbles may remain in the glass when the glass is formed into a sheet shape. Meanwhile, when tin oxide (SnO₂) is introduced as a fining agent into a glass composition for the purpose of reducing bubbles, devitrified stones of SnO₂ are generated, which may make it difficult to form the glass into a sheet shape.

The present invention has been made in view of the above circumstances, and a technical issue of the present invention is to provide a tempered glass sheet that is less likely to be damaged when dropped, that has excellent chemical stability and clarity, and in which devitrified stones is less likely to occur during forming.

### Solution to Problem

As a result of various investigations, the present inventor found that the above technical issue can be solved by limiting a glass composition to a predetermined range, and proposed the finding as the present invention. That is, a tempered glass sheet according to an embodiment of the present invention includes a compression stress layer on the surface and a glass composition containing from 40 to 80 mol % of SiO₂, from 6 to 25 mol % of Al₂O₃, from 0 to 10 mol % of B₂O₃, from 3 to 15 mol % of Li₂O, from 1 to 21 mol % of Na₂O, from 0 to 10 mol % of K₂O, from 0 to 10 mol % of MgO, from 0 to 10 mol % of ZnO, from 0 to 15 mol % of P₂O₅, and from 0.001 to 0.30 mol % of SnO₂, in which ([Li₂O]+[Na₂O]+[K₂O])/[Al₂O₃] is greater than or equal to 0.86, and ([SiO₂]+[B₂O₃]+[P₂O₅])/((100×[SnO₂])×([Al₂O₃]+[Li₂O]+[Na₂O]+[K₂O]+[MgO]+[CaO]+[SrO]+[BaO]+[ZnO])) is greater than or equal to 0.40. Here, “[Li₂O]” refers to the content of Li₂O in mol %. “[Na₂O]” refers to the content of Na₂O in mol %. “[K₂O]” refers to the content of K₂O in mol %. “[Al₂O₃]” refers to the content of Al₂O₃ in mol %. “([Li₂O]+[Na₂O]+[K₂O])/[Al₂O₃]” refers to a value obtained by dividing the sum of the contents of Li₂O, Na₂O and K₂O by the content of Al₂O₃. “[SiO₂]” refers to the content of SiO₂ in mol %. “[1B₂O₃]” refers to the content of B₂O₃ in mol %. “[P₂O₅]” refers to the content of P₂O₅ in mol %. “[SnO₂]” refers to the content of SnO₂ in mol %. “[MgO]” refers to the content of MgO in mol %. “[CaO]” refers to the content of CaO in mol %. “[SrO]” refers to the content of SrO in mol %. “[BaO]” refers to the content of BaO in mol %. “[ZnO]” refers to the content of ZnO in mol %. “(([SiO₂]+[1B₂O₃]+[P₂O₅])/((100×[SnO₂])×([Al₂O₃]+[Li₂O]+[Na₂O]+[K₂O]+[MgO]+[CaO]+[SrO]+[BaO]+[ZnO]))” refers to a value obtained by dividing the sum of the contents of SiO₂, B₂O₃, and P₂O₅ by a value, which is obtained by multiplying 100 times the content of SnO₂ by the sum of the contents of Al₂O₃, Li₂O, Na₂O, K₂O, MgO, CaO, SrO, BaO and ZnO.

In the tempered glass sheet according to an embodiment of the present invention, preferably a content of B₂O₃ is from 0.1 to 3 mol %.

In the tempered glass sheet according to an embodiment of the present invention, preferably a content of SnO₂ is 0.045 mol % or less.

In the tempered glass sheet according to an embodiment of the present invention, preferably a content of Cl is from 0.02 to 0.3 mol %.

A tempered glass sheet according to an embodiment of the present invention includes a compression stress layer on the surface and a glass composition containing from 40 to 80 mol % of SiO₂, from 6 to 25 mol % of Al₂O₃, from 0 to 10 mol % of B₂O₃, from 3 to 15 mol % of Li₂O, from 1 to 21 mol % of Na₂O, from 0 to 10 mol % of K₂O, from 0 to 10 mol % of MgO, from 0 to 10 mol % of ZnO, from 0 to 15 mol % of P₂O₅, from 0.001 to 0.045 mol % of SnO₂, and from 0.02 to 0.3 mol % of Cl, in which ([Li₂O]+[Na₂O]+[K₂O])/[Al₂O₃] is greater than or equal to 0.86, and ([SiO₂]+[B₂O₃]+[P₂O₅])/((100×[SnO₂])×([Al₂O₃]+[Li₂O]+[Na₂O]+[K₂O]+[MgO]+[CaO]+[SrO]+[BaO]+[ZnO])) is greater than or equal to 0.40.

A tempered glass sheet according to an embodiment of the present invention includes a compression stress layer on the surface and a glass composition containing from 40 to 80 mol % of SiO₂, from 6 to 25 mol % of Al₂O₃, from 0.1 to 3 mol % of B₂O₃, from 3 to 15 mol % of Li₂O, from 1 to 21 mol % of Na₂O, from 0 to 10 mol % of K₂O, from 0 to 10 mol % of MgO, from 0 to 10 mol % of ZnO, from 0 to 15 mol % of P₂O₅, from 0.001 to 0.30 mol % of SnO₂, and from 0.02 to 0.3 mol % of Cl, in which ([Li₂O]+[Na₂O]+[K₂O])/[Al₂O₃] is greater than or equal to 0.86, and ([SiO₂]+[B₂O₃]+[P₂O₅])/((100×[SnO₂])×([Al₂O₃]+[Li₂O]+[Na₂O]+[K₂O]+[MgO]+[CaO]+[SrO]+[BaO]+[ZnO])) is greater than or equal to 0.40.

In the tempered glass sheet according to an embodiment of the present invention, preferably a content of P₂O₅ is 2.5 mol % or greater.

In the tempered glass sheet according to an embodiment of the present invention, preferably a content of Fe₂O₃ is from 0.001 to 0.1 mol %.

In the tempered glass sheet according to an embodiment of the present invention, preferably a content of TiO₂ is from 0.001 to 0.1 mol %.

In the tempered glass sheet according to an embodiment of the present invention, preferably a compression stress value on the outermost surface of the compression stress layer is from 200 to 1200 MPa. Here, the expressions “compression stress value on the outermost surface” and “depth of layer” each refer to a value measured based on a retardation distribution curve observed using, for example, a scattered light photoelastic stress meter SLP-1000 (available from Orihara Industrial Co., Ltd.). Moreover, the expression “depth of layer” refers to a depth at which the stress value becomes zero. Note that, the stress characteristics were calculated using a refractive index of 1.51 and an optical elasticity constant of 29.0 [(nm/cm)/MPa] for each sample to be measured.

In the tempered glass sheet according to an embodiment of the present invention, preferably a depth of layer of the compression stress layer is from 50 μm to 200 μm.

In the tempered glass sheet according to an embodiment of the present invention, preferably a compression stress value at the depth of 2.5 μm is 350 MPa or greater. Such configuration increases bending strength

In the tempered glass sheet according to an embodiment of the present invention preferably, an average compression stress value at the depth of from 30 to 45 μm is 85 MPa or greater. Such configuration increases drop resistance strength.

In the tempered glass sheet according to an embodiment of the present invention, preferably a temperature at the viscosity in high temperature of 10^{2.5} dPa·s is less than 1650° C. Here, “temperature at the viscosity in high temperature of 10^{2.5} dPa·s” can be measured by, for example, the platinum sphere pull up method.

The tempered glass sheet according to an embodiment of the present invention preferably includes an overflow-joined surface at the central portion in a sheet thickness direction. Here, “overflow downdraw method” is a method of manufacturing a glass sheet, in which molten glass overflows from both sides of a refractory forming body, and the overflowed molten glass joins at the lower end of the refractory forming body while being drawn downward, forming a glass sheet.

The tempered glass sheet according to an embodiment of the present invention is preferably for use as a cover glass for a touch panel display.

The tempered glass sheet according to an embodiment of the present invention preferably has a stress profile in a thickness direction including at least a first peak, a second peak, a first bottom, and a second bottom.

A method of manufacturing a tempered glass sheet according to an embodiment of the present invention includes a preparation step and an ion exchange step, the preparation step including preparing a glass sheet to be tempered including a glass composition containing from 40 to 80 mol % of SiO₂, from 6 to 25 mol % of Al₂O₃, from 0 to 10 mol % of B₂O₃, from 3 to 15 mol % of Li₂O, from 1 to 21 mol % of Na₂O, from 0 to 10 mol % of K₂O, from 0 to 10 mol % of MgO, from 0 to 10 mol % of ZnO, from 0 to 15 mol % of P₂O₅, and from 0.001 to 0.30 mol % of SnO₂, in which ([Li₂O]+[Na₂O]+[K₂O])/[Al₂O₃] is greater than or equal to 0.86, and ([SiO₂]+[B₂O₃]+[P₂O₅])/((100×[SnO₂])×([Al₂O₃]+[Li₂O]+[Na₂O]+[K₂O]+[MgO]+[CaO]+[SrO]+[BaO]+[ZnO])) is greater than or equal to 0.40, the ion exchange step including, by subjecting the glass sheet to be tempered to a plurality of ion exchange treatments, obtaining a tempered glass sheet including a compression stress layer on the surface.

A glass sheet to be tempered according to an embodiment of the present invention is an ion-exchangeable glass sheet to be tempered including a glass composition containing from 40 to 80 mol % of SiO₂, from 6 to 25 mol % of Al₂O₃, from 0 to 10 mol % of B₂O₃, from 3 to 15 mol % of Li₂O, from 1 to 21 mol % of Na₂O, from 0 to 10 mol % of K₂O, from 0 to 10 mol % of MgO, from 0 to 10 mol % of ZnO, from 0 to 15 mol % of P₂O₅, and from 0.001 to 0.30 mol % of SnO₂, in which ([Li₂O]+[Na₂O]+[K₂O])/[Al₂O₃] is greater than or equal to 0.86, and ([SiO₂]+[B₂O₃]+[P₂O₅])/((100×[SnO₂])×([Al₂O₃]+[Li₂O]+[Na₂O]+[K₂O]+[MgO]+[CaO]+[SrO]+[BaO]+[ZnO])) is greater than or equal to 0.40.

A glass sheet to be tempered according to an embodiment of the present invention is an ion-exchangeable glass sheet to be tempered including a glass composition containing from 40 to 80 mol % of SiO₂, from 6 to 25 mol % of Al₂O₃, from 0 to 10 mol % of B₂O₃, from 3 to 15 mol % of Li₂O, from 1 to 21 mol % of Na₂O, from 0 to 10 mol % of K₂O, from 0 to 10 mol % of MgO, from 0 to 10 mol % of ZnO, from 0 to 15 mol % of P₂O₅, from 0.001 to 0.045 mol % of SnO₂, and from 0.02 to 0.3 mol % of Cl, in which ([Li₂O]+[Na₂O]+[K₂O])/[Al₂O₃] is greater than or equal to 0.86, and ([SiO₂]+[B₂O₃]+[P₂O₅])/((100×[SnO₂])×([Al₂O₃]+[Li₂O]+[Na₂O]+[K₂O]+[MgO]+[CaO]+[SrO]+[BaO]+[ZnO])) is greater than or equal to 0.40.

A glass sheet to be tempered according to an embodiment of the present invention is an ion-exchangeable glass sheet to be tempered including a glass composition containing from 40 to 80 mol % of SiO₂, from 6 to 25 mol % of Al₂O₃, from 0.1 to 3 mol % of B₂O₃, from 3 to 15 mol % of Li₂O, from 1 to 21 mol % of Na₂O, from 0 to 10 mol % of K₂O, from 0 to 10 mol % of MgO, from 0 to 10 mol % of ZnO, from 0 to 15 mol % of P₂O₅, from 0.001 to 0.30 mol % of SnO₂, and from 0.02 to 0.3 mol % of Cl, in which ([Li₂O]+[Na₂O]+[K₂O])/[Al₂O₃] is greater than or equal to 0.86, and ([SiO₂]+[B₂O₃]+[P₂O₅])/((100×[SnO₂])×([Al₂O₃]+[Li₂O]+[Na₂O]+[K₂O]+[MgO]+[CaO]+[SrO]+[BaO]+[ZnO])) is greater than or equal to 0.40.

### BRIEF DESCRIPTION OF DRAWINGS

FIG. 1 is an explanatory diagram illustrating a stress profile having a first peak, a second peak, a first bottom, and a second bottom.

FIG. 2 is a stress profile of a tempered glass sheet according to Example 3.

FIG. 3 is a stress profile of a tempered glass sheet according to Example 3.

### DESCRIPTION OF EMBODIMENTS

A tempered glass sheet (glass sheet to be tempered) according to an embodiment of the present invention includes a compression stress layer on the surface and a glass composition containing from 40 to 80 mol % of SiO₂, from 6 to 25 mol % of Al₂O₃, from 0 to 10 mol % of B₂O₃, from 3 to 15 mol % of Li₂O, from 1 to 21 mol % of Na₂O, from 0 to 10 mol % of K₂O, from 0 to 10 mol % of MgO, from 0 to 10 mol % of ZnO, from 0 to 15 mol % of P₂O₅, and from 0.001 to 0.30 mol % of SnO₂, in which ([Li₂O]+[Na₂O]+[K₂O])/[Al₂O₃] is greater than or equal to 0.86, and ([SiO₂]+[B₂O₃]+[P₂O₅])/((100×[SnO₂])×([Al₂O₃]+[Li₂O]+[Na₂O]+[K₂O]+[MgO]+[CaO]+[SrO]+[BaO]+[ZnO])) is greater than or equal to 0.40. The reason for limiting the content range of each component will be described below. Note that, in description of the content range of each component, “%” refers to “mol %” unless otherwise specified.

SiO₂ is a component that forms the network of the glass. When the content of SiO₂ is too small, vitrification is difficult, and a thermal expansion coefficient is too high, and thus the thermal shock resistance is likely to decrease. Thus, the lower limit of the content range of SiO₂ is preferably 40% or greater, 45% or greater, 50% or greater, 55% or greater, or 57% or greater, and particularly preferably 59% or greater. On the other hand, when the content of SiO₂ is too large, meltability and formability are likely to decrease, the thermal expansion coefficient is too low, and thus it is difficult to match the thermal expansion coefficient of the peripheral material.

Thus, the upper limit of the content range of SiO₂ is preferably 80% or less, 70% or less, 68% or less, 66% or less, 65% or less, 64.5% or less, 64% or less, or 63% or less, and particularly preferably 62% or less.

Al₂O₃ is a component that enhances ion exchange performance, and is also a component that increases a strain point, Young's modulus, fracture toughness, and Vickers hardness. Thus, the lower limit of the content range of Al₂O₃ is preferably 6% or greater, 7% or greater, 8% or greater, 10% or greater, 12% or greater, 13% or greater, 14% or greater, 14.4% or greater, 15% or greater, 15.3% or greater, 15.6% or greater, 16% or greater, 16.5% or greater, 17% or greater, 17.2% or greater, 17.5% or greater, 17.8% or greater, 18% or greater, greater than 18%, or 18.3% or greater, and particularly preferably 18.5% or greater, 18.6% or greater, 18.7% or greater, or 18.8% or greater. On the other hand, when the content of Al₂O₃ is too large, a viscosity in high temperature increases, and thus the meltability and formability are likely to decrease. In addition, devitrified crystals are likely to precipitate in the glass, making it difficult to form the glass into a sheet shape using the overflow downdraw method or the like. In particular, when an alumina-based refractory is used as a refractory forming body to form the glass into a sheet shape using the overflow downdraw method, devitrified crystals of spinel are likely to precipitate at the interface with the alumina-based refractory. Furthermore, oxidation resistance also decreases, and thus it is difficult to be applied to an acid treatment process. Thus, the suitable upper limit range of Al₂O₃ is 25% or less, 21% or less, 20.5% or less, 20% or less, 19.9% or less, 19.5% or less, 19.0% or less, and in particular 18.9% or less. When the content of Al₂O₃, which has a large influence on ion exchange performance, is in the preferred range, a profile having a first peak, a second peak, a first bottom, and a second bottom forms easily.

B₂O₃ is a component that lowers viscosity in high temperature or density, stabilizes the glass to make it difficult for crystals to precipitate, and lowers liquidus temperature. B₂O₃ is also a component that increases the binding force of oxygen electrons by cations and that lowers the basicity of the glass. When the content of B₂O₃ is too small, the depth of layer in the ion exchange between Li ions contained in the glass and Na ions in a molten salt becomes too large, and as a result, the compression stress value of the compression stress layer (CS_{Na}) is likely to become small. In addition, the glass may become unstable, and devitrification resistance may decrease. In addition, the basicity of the glass may become too high, the amount of 02 released by the reaction of a fining agent may become small, bubble formation property may decrease, and bubbles may remain in the glass when the glass is formed into a sheet shape. Thus, the lower limit of the content range of B₂O₃ is preferably 0% or greater, 0.10% or greater, 0.12% or greater, 0.15% or greater, 0.18% or greater, 0.20% or greater, 0.23% or greater, 0.25% or greater, 0.27% or greater, 0.30% or greater, or 0.35% or greater, and particularly preferably 0.4% or greater. Meanwhile, when the content of B₂O₃ is too large, the depth of layer may become small. In particular, the efficiency of ion exchange between the Na ions contained in the glass and K ions in a molten salt is likely to decrease, and the depth of layer of the compression stress layer (DOL_ZERO_{K}) is likely to decrease. Thus, the upper limit of the content range of B₂O₃ is preferably 10% or less, 5% or less, 4% or less, 3.8% or less, 3.5% or less, 3.3% or less, 3.2% or less, 3.1% or less, 3% or less, 2.9% or less, 2.8% or less, 2.5% or less, 2.0% or less, 1.5% or less, 1.0% or less, less than 1.0%, or 0.8% or less, and particularly preferably 0.5% or less. When the content of B₂O₃ is in the preferred range, a profile having a first peak, a second peak, a first bottom, and a second bottom forms easily.

Alkali metal oxides are ion exchange components, and are also components that lower viscosity in high temperature to increase meltability or formability. However, when the content of alkali metal oxides ([Li₂O]+[Na₂O]+[K₂O]) is too large, thermal expansion coefficient may increase. Further, acid resistance may decrease. Thus, the lower limit of the content range of alkali metal oxides ([Li₂O]+[Na₂O]+[K₂O]) is preferably 10% or greater, 11% or greater, 12% or greater, 13% or greater, 14% or greater, 14.2% or greater, 14.5% or greater, 14.8% or greater, 15% or greater, 15.2% or greater, 15.5% or greater, or 15.8% or greater, and particularly preferably 16% or greater; meanwhile, the upper limit of the content range of alkali metal oxides ([Li₂O]+[Na₂O]+[K₂O]) is preferably 25% or less, 23% or less, 20% or less, or 19% or less, and particularly preferably 18% or less.

Li₂O is an ion exchange component, and in particular, an essential component for exchanging the Li ions contained in the glass with the Na ions in a molten salt to achieve a large depth of layer. Li₂O is also a component that lowers viscosity in high temperature to increase meltability or formability and a component that increases the Young's modulus. Thus, the lower limit of the content range of Li₂O is preferably 3% or greater, 4% or greater, 5% or greater, 5.5% or greater, 6.5% or greater, 7% or greater, 7.3% or greater, 7.5% or greater, or 7.8% or greater, and particularly preferably 8% or greater. Thus, the upper limit of the content range of Li₂O is preferably 15% or less, 13% or less, 12% or less, 11.5% or less, 11% or less, 10.5% or less, less than 10%, 9.9% or less, or 9% or less, and particularly preferably 8.9% or less.

Na₂O is an ion exchange component, and is also a component that lowers the viscosity in high temperature to enhance meltability and formability. Na₂O is also a component that improves devitrification resistance, and in particular, a component that suppresses devitrification caused by reaction with an alumina-based refractory. Thus, the lower limit of the content range of Na₂O is preferably 1% or greater, 2% or greater, 3% or greater, 4% or greater, 5% or greater, 6% or greater, 7% or greater, 7.5% or greater, 8% or greater, 8.5% or greater, or 8.8% or greater, and particularly preferably 9% or greater. Meanwhile, when the content of Na₂O is too large, thermal expansion coefficient is too high, and thus thermal shock resistance is likely to decrease. In addition, the component balance of the glass composition is lacked, and thus the devitrification resistance may be reduced. Thus, the upper limit of the content range of Na₂O is preferably 21% or less, 20% or less, or 19% or less, and particularly preferably 18% or less, 15% or less, 13% or less, or 11% or less, and particularly preferably 10% or less.

K₂O is a component that lowers the viscosity in high temperature and enhances the meltability and formability. However, when the content of K₂O is too large, thermal expansion coefficient is too high, and thermal shock resistance is likely to decrease. The compression stress value on the outermost surface is also likely to decrease. Thus, the upper limit of the content range of K₂O is preferably 10% or less, 7% or less, 6% or less, 5% or less, 4% or less, 3% or less, or 2% or less, and particularly preferably 1.5% or less. Note that, when attention is given to the viewpoint of increasing the depth of layer, the lower limit of the content range of K₂O is preferably 0% or greater, 0.1% or greater, or 0.3% or greater, and particularly preferably 0.4% or greater.

The lower limit of the content range of ([Li₂O]+[Na₂O]+[K₂O])/[Al₂O₃] is preferably 0.86 or greater, or 0.87 or greater, and particularly preferably 0.88 or greater. When ([Li₂O]+[Na₂O]+[K₂O])/[Al₂O₃] is too small, the efficiency of ion exchange is likely to decrease.

Meanwhile, when the molar ratio ([Li₂O]+[Na₂O]+[K₂O])/[Al₂O₃] is too large, the efficiency of ion exchange is also likely to decrease. Thus, the upper limit of the content range of ([Li₂O]+[Na₂O]+[K₂O])/[Al₂O₃] is preferably 2.0 or less, 1.8 or less, 1.7 or less, 1.6 or less, 1.5 or less, 1.4 or less, 1.3 or less, 1.2 or less, 1.1 or less, or 1.0 or less, and particularly preferably 0.95 or less.

([SiO₂]+[B₂O₃]+[P₂O₅])/((100×[SnO₂])×([Li₂O]+[Na₂O]+[K₂O]+[MgO]+[CaO]+[SrO]+[BaO]+[ZnO]+[Al₂O₃])) is preferably 0.40 or greater, 0.41 or greater, 0.42 or greater, 0.43 or greater, 0.44 or greater, 0.45 or greater, 0.48 or greater, 0.50 or greater, 0.51 or greater, 0.52 or greater, 0.53 or greater, or 0.54 or greater, and particularly preferably 0.55 or greater. When the molar ratio ([SiO₂]+[B₂O₃]+[P₂O₅])/((100×[SnO₂])×([Li₂O]+[Na₂O]+[K₂O]+[MgO]+[CaO]+[SrO]+[BaO]+[ZnO]+[Al₂O₃])) is too small, SnO₂ stones are likely to precipitate. In addition, the amount of oxygen released from a fining agent during melting and forming is likely to decrease, and bubbles are likely to remain in the glass when the glass is formed into a sheet shape. The upper limit of ([SiO₂]+[B₂O₃]+[P₂O₅])/((100×[SnO₂])×([Li₂O]+[Na₂O]+[K₂O]+[MgO]+[CaO]+[SrO]+[BaO]+[ZnO]+[Al₂O₃])) is not limited, but is preferably 4.0 or less, 3.0 or less, 2.0 or less, 1.8 or less, 1.5 or less, 1.2 or less, 1.0 or less, 0.90 or less, or 0.80 or less, and particularly preferably 0.70 or less, for the purpose of suppressing devitrification while increasing clarity.

[Li₂O]/([Na₂O]+[K₂O]) is preferably from 0.4 to 1.0, or from 0.5 to 0.9, and particularly preferably from 0.6 to 0.8. When [Li₂O]/([Na₂O]+[K₂O]) is too small, ion exchange performance may not be sufficiently exhibited. In particular, the efficiency of ion exchange between the Li ions contained in the glass and the Na ions in a molten salt is likely to decrease. Meanwhile, when the molar ratio [Li₂O]/([Na₂O]+[K₂O]) is too large, devitrified crystals are likely to precipitate in the glass, making it difficult to form the glass into a sheet shape using the overflow downdraw method or the like. Note that, [Li₂O]/([Na₂O]+[K₂O]) refers to a value obtained by dividing the content of Li₂O by the sum of the contents of Na₂O and K₂O.

MgO is a component that lowers viscosity in high temperature to increase meltability or formability and that raises strain point or the Vickers hardness. MgO is also a component that, among alkaline earth metal oxides, has a large effect on improving ion exchange performance. However, when the content of MgO is too large, devitrification resistance is likely to decrease, and in particular, devitrification caused by the reaction with an alumina-based refractory becomes difficult to suppress. Thus, the content of MgO is preferably from 0 to 10%, from 0 to 7%, from 0 to 5%, from 0.1 to 3%, from 0.2 to 2.5%, from 0.3 to 2%, or from 0.4 to 1.5%, and particularly preferably from 0.5 to 1.0%.

Compared with other components, CaO is a component that lowers viscosity in high temperature to improve meltability or formability and that raises strain point or the Vickers hardness without reducing devitrification resistance. However, when the content of CaO is too large, ion exchange performance may decrease, or an ion exchange solution may deteriorate during ion exchange treatments. Thus, the upper limit of the content range of CaO is preferably 6% or less, 5% or less, 4% or less, 3.5% or less, 3% or less, 2% or less, 1% or less, less than 1%, 0.7% or less, 0.5% or less, 0.3% or less, 0.1% or less, or 0.05% or less, and particularly preferably 0.01% or less.

SrO and BaO are components that lower viscosity in high temperature to increase meltability or formability, and that raise strain point or the Young's modulus. However, when the contents of SrO and BaO are too large, ion exchange reaction is likely to be inhibited, and in addition, density or thermal expansion coefficient may be unduly high, and the glass is likely to devitrify. Thus, the contents of SrO and BaO are each preferably from 0 to 2%, from 0 to 1.5%, from 0 to 1%, from 0 to 0.5%, or from 0 to 0.1%, and particularly preferably 0 and greater and less than 0.1%.

ZnO is a component that improves ion exchange performance and, in particular, a component that has a large effect on increasing the compression stress value on the outermost surface. It is also a component that reduces viscous properties at high temperatures without reducing viscous properties at low temperatures. The lower limit of the content range of ZnO is preferably 0% or greater, 0.1% or greater, 0.3% or greater, 0.5% or greater, or 0.7% or greater, and particularly preferably 1% or greater. Meanwhile, when the content of ZnO is too large, the glass tends to phase-separate, devitrification resistance tends to decrease, density tends to increase, or the depth of layer tends to become small. Thus, the upper limit of the content range of ZnO is preferably 10% or less, 6% or less, 5% or less, 4% or less, 3% or less, 2% or less, 1.5% or less, 1.3% or less, or 1.2% or less, and particularly preferably 1.1% or less.

P₂O₅ is a component that improves ion exchange performance, and, in particular, a component that increases the depth of layer. P₂O₅ is also a component that improves acid resistance. P₂O₅ is also a component that increases the binding force of oxygen electrons by cations and that lowers the basicity of the glass. When the content of P₂O₅ is too small, ion exchange performance may not be sufficiently exhibited. In particular, the efficiency of ion exchange between the Na ions contained in the glass and the K ions in a molten salt is likely to decrease, and the depth of layer of the compression stress layer (DOL_ZERO_{K}) is likely to decrease. In addition, the glass may become unstable, and devitrification resistance may decrease. In addition, the basicity of the glass may become too high, the amount of O₂ released by the reaction of a fining agent may become small, bubble formation property may decrease, and bubbles may remain in the glass when the glass is formed into a sheet shape. Thus, the lower limit of the content range of P₂O₅ is preferably 0% or greater, 0.1% or greater, 0.4% or greater, 0.7% or greater, 1% or greater, 1.2% or greater, 1.4% or greater, 1.6% or greater, 2% or greater, 2.3% or greater, 2.5% or greater, 2.6% or greater, 2.7% or greater, 2.8% or greater, 2.9% or greater, 3.0% or greater, 3.2% or greater, 3.5% or greater, 3.8% or greater, 3.9% or greater, 4.0% or greater, 4.1% or greater, 4.2% or greater, 4.3% or greater, 4.4% or greater, or 4.5% or greater, and particularly preferably 4.6% or greater. Meanwhile, when the content of P₂O₅ is too large, the glass is likely to phase-separate, or water resistance is likely to decrease. In addition, the depth of layer in the ion exchange between the Li ions contained in the glass and the Na ions in a molten salt becomes too large, and as a result, the compression stress value of the compression stress layer (CS_{Na}) is likely to become small. Thus, the upper limit of the content range of P₂O₅ is preferably 15% or less, 10% or less, 8% or less, 7% or less, 6% or less, 5% or less, 4.9% or less, or 4.8% or less. When the content of P₂O₅ is within the preferred range, a non-monotonic profile forms easily.

([SiO₂]+1.2×[P₂O₅])−(3×[Al₂O₃]+2×[Li₂O]+1.5×[Na₂O]+[K₂O]+[B₂O₃]) is preferably −40% or greater, −30% or greater, −25% or greater, −24% or greater, −23% or greater, −22% or greater, −21% or greater, −20% or greater, or −19% or greater, and particularly preferably −18% or greater. When ([SiO₂]+1.2×[P₂O₅])−(3×[Al₂O₃]+2×[Li₂O]+1.5×[Na₂O]+[K₂O]+[B₂O₃]) is too small, acid resistance is likely to decrease. Meanwhile, when ([SiO₂]+1.2×[P₂O₅])−(3×[Al₂O₃]+2×[Li₂O]+1.5×[Na₂O]+[K₂O]+[B₂O₃]) is too large, ion exchange performance may not be sufficiently exhibited. As such, ([SiO₂]+1.2×[P₂O₅])−(3×[Al₂O₃]+2×[Li₂O]+1.5×[Na₂O]+[K₂O]+[B₂O₃]) is preferably 30 mol % or less, 20 mol % or less, 15 mol % or less, 10 mol % or less, or 5 mol % or less, and particularly preferably 0 mol % or less. Note that, ([SiO₂]+1.2×[P₂O₅])−(3×[Al₂O₃]+2×[Li₂O]+1.5×[Na₂O]+[K₂O]+[B₂O₃]) refers to a value obtained by subtracting the sum of 3 times the content of Al₂O₃, 2 times the content of Li₂O, 1.5 times the content of Na₂O, the content of K₂O, and the content of B₂O₃ from the sum of the content of SiO₂ and 1.2 times the content of P₂O₅.

SnO₂ is a fining agent and a component that improves ion exchange performance. However, when the content of SnO₂ is too large, devitrification resistance is likely to decrease. Thus, the lower limit of the content range of SnO₂ is preferably 0.001% or greater, 0.002% or greater, 0.005% or greater, or 0.007% or greater, and particularly preferably 0.010% or greater; meanwhile, the upper limit of the content range of SnO₂ is preferably 0.30% or less, 0.27% or less, 0.25% or less, 0.20% or less, 0.18% or less, 0.15% or less, 0.12% or less, 0.10% or less, 0.09% or less, 0.08% or less, 0.07% or less, 0.06% or less, 0.05% or less, 0.047% or less, 0.045% or less, 0.042% or less, 0.040% or less, 0.038% or less, 0.035% or less, or 0.032% or less, and particularly preferably 0.030% or less.

In addition to the above components, for example, the following components may be added.

ZrO₂ is a component that increases the Vickers hardness and also a component that increases viscosity or strain point near liquidus viscosity. However, when the content of ZrO₂ is too large, devitrification resistance may decrease significantly. Thus, the content of ZrO₂ is preferably from 0 to 3%, from 0 to 1.5%, or from 0 to 1%, and particularly preferably from 0 to 0.1%.

TiO₂ is a component that improves ion exchange performance and lowers viscosity in high temperature. However, when the content of TiO₂ is too large, transparency or devitrification resistance is likely to decrease. Thus, the content of TiO₂ is preferably from 0 to 3%, from 0 to 1.5%, from 0 to 1%, or from 0 to 0.1%, and particularly preferably from 0.001 to 0.1%.

Cl is a fining agent. In particular, when SnO₂ is used in combination with Cl, the size of bubbles in the glass is likely to increase, and the fining effect is easily exhibited. As such, when SnO₂ and Cl are used in combination, the fining effect can be maintained even if the content of SnO₂ is reduced. Meanwhile, when the content of Cl is too large, it is a component that adversely affects the environment and equipment. Thus, the lower limit of the content range of Cl is preferably 0% or greater, 0.001% or greater, 0.005% or greater, 0.008% or greater, 0.010% or greater, 0.015% or greater, 0.018% or greater, 0.019% or greater, 0.020% or greater, 0.021% or greater, 0.022% or greater, 0.023% or greater, 0.024% or greater, 0.025% or greater, 0.027% or greater, 0.030% or greater, 0.035% or greater, 0.040% or greater, 0.050% or greater, 0.070% or greater, or 0.090% or greater, and particularly 0.100% or greater; meanwhile, the upper limit of the content range of Cl is preferably 0.3% or less, 0.2% or less, 0.17% or less, or 0.15% or less, and particularly preferably 0.12% or less.

In addition to the above, from 0.001 to 1% of SO₃ or CeO₂ may be added as a fining agent.

Fe₂O₃ is an impurity that unavoidably gets mixed in from raw materials. The content of Fe₂O₃ is preferably less than 1000 ppm (less than 0.1%), less than 800 ppm, less than 600 ppm, or less than 400 ppm, and particularly preferably less than 300 ppm. When the content of Fe₂O₃ is too large, the transmittance of the cover glass is likely to decrease. Meanwhile, the lower limit of the content range of Fe₂O₃ is preferably 10 ppm or greater, 20 ppm or greater, 30 ppm or greater, 50 ppm or greater, or 80 ppm or greater, and particularly preferably 100 ppm or greater. When the content of Fe₂O₃ is too small, the cost of raw materials is likely to increase due to the use of high-purity raw materials.

Rare earth oxides such as Nd₂O₃, La₂O₃, Y₂O₃, Nb₂O₅, Ta₂O₅, and Hf₂O₃ are components that increase the Young's modulus. However, the raw material cost is high, and when the rare earth oxides are added in a large amount, devitrification resistance is likely to decrease. Thus, the content of rare earth oxides is preferably 5% or less, 4% or less, 3% or less, 2% or less, 1% or less, or 0.5% or less, and particularly preferably 0.1% or less.

From environmental considerations, the tempered glass sheet (glass sheet to be tempered) according to an embodiment of the present invention preferably has a glass composition that is substantially free of As₂O₃, Sb₂O₃, PbO, and F. Also from environmental considerations, the tempered glass sheet (glass sheet to be tempered) according to an embodiment of the present invention preferably has a glass composition that is substantially free of Bi₂O₃. The expression “substantially free of” means that although a specified component is not actively added as a glass component, the addition of the specified component at an impurity level is permitted. Specifically, the expression refers to the case in which the content of the specified component is less than 0.05%.

The tempered glass sheet (glass sheet to be tempered) according to an embodiment of the present invention preferably has the following properties.

The tempered glass sheet (glass sheet to be tempered) according to an embodiment of the present invention preferably has a density of 2.55 g/cm³ or less, 2.53 g/cm³ or less, 2.50 g/cm³ or less, 2.49 g/cm³ or less, or 2.45 g/cm³ or less, and particularly preferably from 2.35 to 2.44 g/cm³. The lower the density, the lighter the tempered glass sheet can be. Note that, “density” is a value that can be measured by, for example, the well-known Archimedes method.

The tempered glass sheet (glass sheet to be tempered) according to an embodiment of the present invention preferably has a thermal expansion coefficient at from 30 to 380° C. of 150×10⁻⁷/° C. or less, or 100×10⁻⁷/° C. or less, and particularly preferably from 50×10⁻⁷ to 95×10⁻⁷/° C. Note that, “thermal expansion coefficient at from 30 to 380° C.” refers to a value obtained by measuring an average thermal expansion coefficient using a dilatometer.

The tempered glass sheet (glass sheet to be tempered) according to an embodiment of the present invention preferably has a softening point of 950° C. or less, 930° C. or less, 920° C. or less, 910° C. or less, or 900° C. or less, and particularly preferably from 880 to 900° C. When the softening point is too high, bending by heat treatment becomes difficult. Note that, “softening point” refers to a value measured based on the method of ASTM C338.

The tempered glass sheet (glass sheet to be tempered) according to an embodiment of the present invention preferably has a temperature at the viscosity in high temperature of 10^{2.5} dPa·s of 1660° C. or less, less than 1600° C., 1590° C. or less, 1580° C. or less, 1570° C. or less, or 1560° C. or less, and particularly preferably from 1400 to 1550° C. When the temperature at the viscosity in high temperature of 10^{2.5} dPa·s is too high, meltability and formability deteriorates, making it difficult to form the molten glass into a sheet shape. Note that, the expression “temperature at the viscosity in high temperature of 10^{2.5} dPa·s” refers to a value measured by the platinum sphere pull up method.

The tempered glass sheet (glass sheet to be tempered) according to an embodiment of the present invention preferably has a liquidus viscosity of 10^{3.74} dPa·s or greater, 10^{4.5} dPa·s or greater, 10^{4.8} dPa·s or greater, 10^{4.9} dPa·s or greater, 10^{5.0} dPa·s or greater, 10^{5.1} dPa·s or greater, 10^{5.2} dPa·s or greater, 10^{5.3} dPa·s or greater, or 10⁴ dPa·s or greater, and particularly preferably 10^{5.5} dPa·s or greater. Note that, the higher the liquidus viscosity is, the more devitrification resistance is improved, and the less likely for devitrified stones to occur during forming. Here, “liquidus viscosity” refers to a value obtained by measuring the viscosity at the liquidus temperature using the platinum sphere pull up method. The term “liquidus temperature” refers to the following. Glass powder that passed through a standard 30-mesh sieve (500 μm) and remained on a 50-mesh sieve (300 μm) is placed in a platinum boat and kept in a gradient heating furnace for 24 hours. After that, the platinum boat is taken out, and the highest temperature at which devitrification (devitrified stones) inside the glass is observed via a microscope is defined as the “liquidus temperature”.

The tempered glass sheet (glass sheet to be tempered) according to an embodiment of the present invention preferably has a Young's modulus of 70 GPa or greater, 74 GPa or greater, or from 75 to 100, and particularly preferably from 76 to 90. When the Young's modulus is low, the cover glass tends to bend in a case in which the sheet thickness is small. Note that, “Young's modulus” can be calculated by a well-known resonance method.

The tempered glass sheet according to an embodiment of the present invention has a compression stress layer on the surface. The compression stress value on the outermost surface is preferably 200 MPa or greater, 220 MPa or greater, 250 MPa or greater, 280 MPa or greater, 300 MPa or greater, or 310 MPa or greater, and particularly preferably 320 MPa or greater. The higher the compression stress value on the outermost surface, the higher the Vickers hardness. Meanwhile, when an extremely large compression stress is formed on the surface, the tensile stress inherent in the tempered glass may become extremely high, and dimensional change before and after ion exchange treatments may become large. As such, the compression stress value on the outermost surface is preferably 1200 MPa or less, 1100 MPa or less, 1000 MPa or less, 900 MPa or less, 700 MPa or less, 680 MPa or less, or 650 MPa or less, and particularly preferably 600 MPa or less. Noter that the compression stress value on the outermost surface tends to increase when the ion exchange time is decreased or when the temperature of the ion exchange solution is lowered.

The tempered glass sheet (glass sheet to be tempered) according to an embodiment of the present invention preferably has a depth of layer of 50 μm or greater, 60 μm or greater, 80 μm or greater, 100 μm or greater, 110 μm or greater, 120 μm or greater, or 130 μm or greater, and particularly preferably 140 μm or greater. The larger the depth of layer, the less likely it is for protrusions or sand grains on the pavement to reach the tensile stress layer when a smart phone is dropped, and thus the probability of cover glass damage can be reduced. Meanwhile, when the depth of layer is too large, dimensional change before and after ion exchange treatments may become large. Furthermore, the compression stress value on the outermost surface tends to decrease. Thus, the depth of layer is preferably 200 μm or less, or 180 μm or less, and particularly preferably 170 μm or less. Note that the depth of layer tends to increase when the ion exchange time is increased or when the temperature of the ion exchange solution is raised.

The tempered glass sheet (glass sheet to be tempered) according to an embodiment of the present invention preferably has a compression stress value at the depth of 2.5 μm of 350 MPa or greater, 360 MPa or greater, 370 MPa or greater, 380 MPa or greater, 390 MPa or greater, 400 MPa or greater, 410 MPa or greater, 420 MPa or greater, 430 MPa or greater, 440 MPa or greater, 450 MPa or greater, 460 MPa or greater, 470 MPa or greater, 480 MPa or greater, 490 MPa or greater, 500 MPa or greater, 510 MPa or greater, 520 MPa or greater, 530 MPa or greater, 540 MPa or greater, or 550 MPa or greater, and particularly preferably 600 MPa or greater. The larger the compression stress value at the depth of 2.5 μm, the larger the bending strength. Meanwhile, when an extremely large compression stress is formed at the depth of 2.5 μm, the tensile stress inherent in the tempered glass sheet may become extremely high. As such, the compression stress value at the depth of 2.5 μm is preferably 800 MPa or less, 750 MPa or less, 730 MPa or less, 700 MPa or less, 680 MPa or less, 650 MPa or less, or 640 MPa or less, and particularly preferably 630 MPa or less.

The tempered glass sheet (glass sheet to be tempered) according to an embodiment of the present invention preferably has an average compression stress value at the depth of from 30 to 45 μm of 85 MPa or greater, 86 MPa or greater, 87 MPa or greater, 88 MPa or greater, 89 MPa or greater, 90 MPa or greater, 92 MPa or greater, 95 MPa or greater, or 98 MPa or greater, and particularly preferably 100 MPa or greater. The larger the average compression stress value at the depth of from 30 to 45 μm, the less likely cracks resulting from protrusions or sand grains on the pavement will occur when a smart phone is dropped, and thus the probability of cover glass damage can be reduced. Meanwhile, when the average compression stress value at the depth of from 30 to 45 μm becomes extremely large, the tensile stress inherent in the tempered glass sheet may become extremely high. As such, the average compression stress value at the depth of from 30 to 45 μm is preferably 150 MPa or less, 140 MPa or less, 130 MPa or less, 125 MPa or less, 120 MPa or less, 115 MPa or less, or 110 MPa or less, and particularly preferably 105 MPa or less.

The tempered glass sheet according to an embodiment of the present invention preferably has a sheet thickness of 2.0 mm or less, 1.5 mm or less, 1.3 mm or less, 1.1 mm or less, 1.0 mm or less, or 0.9 mm or less, and particularly preferably 0.8 mm or less. The smaller the sheet thickness, the lighter the tempered glass sheet can be. Meanwhile, when the sheet thickness is too small, a desired mechanical strength becomes difficult to achieve. Thus, the sheet thickness is preferably 0.3 mm or greater, 0.4 mm or greater, 0.5 mm or greater, or 0.6 mm or greater, and particularly preferably 0.7 mm or greater.

A method of manufacturing a tempered glass sheet according to an embodiment of the present invention includes a preparation step and an ion exchange step, the preparation step including preparing a glass sheet to be tempered including the glass composition described above, the ion exchange step including, by subjecting the glass sheet to be tempered to a plurality of ion exchange treatments, obtaining a tempered glass sheet including a compression stress layer on the surface. Note that, although the method of manufacturing a tempered glass sheet according to an embodiment of the present invention includes performing a plurality of ion exchange treatments, the tempered glass sheet according to an embodiment of the present invention includes not only the case in which ion exchange treatment is performed multiple times but also the case in which ion exchange treatment is performed only once.

A method of manufacturing the glass to be tempered according to an embodiment of the present invention is, for example, as follows. Preferably, first, glass raw materials mixed to give a desired glass composition are put into a continuous melting furnace, and heated and melted at from 1400 to 1700° C.; after fining, the resulting molten glass is supplied to a forming device, formed into a sheet shape, and cooled. After the glass is formed into a sheet shape, a well-known method can be used to cut the glass into a predetermined size.

The overflow downdraw method is preferably used as the method of forming the molten glass into a sheet shape. In the overflow downdraw method, surfaces to become the surface of a glass sheet do not come into contact with the surface of the refractory forming body, and glass is formed into a sheet shape in a free-surface state. As such, an unpolished glass sheet with good surface quality can be manufactured at a low cost. Further, in the overflow downdraw method, an alumina-based refractory or a zirconia-based refractory is used as the refractory forming body. The tempered glass sheet (glass sheet to be tempered) according to an embodiment of the present invention has good compatibility with an alumina-based refractory and a zirconia-based refractory (particularly an alumina-based refractory), and thus the tempered glass sheet (glass sheet to be tempered) according to an embodiment of the present invention is less likely to react with these refractories to generate bubbles or stones.

Various forming methods can be used aside from the overflow downdraw method. For example, forming methods such as a float method, a downdraw method (slot downdraw method, redraw method, etc.), a roll-out method, or a press method can be used.

When subjecting the molten glass to forming, the molten glass is preferably cooled at a cooling rate of 3° C./min or greater and less than 1000° C./min in the temperature range between the annealing point and the strain point of the molten glass. The lower limit of the cooling rate is preferably 10° C./min or greater, 20° C./min or greater, or 30° C./min or greater, and particularly preferably 50° C./min or greater. The upper limit of the cooling rate is preferably less than 1000° C./min, or less than 500° C./min, and particularly preferably less than 300° C./min. When the cooling rate is too fast, the structure of the glass becomes rough, making it difficult to increase the Vickers hardness after ion exchange treatments. Meanwhile, when the cooling rate is too slow, production efficiency of the glass sheet decreases.

In the method of manufacturing a tempered glass sheet according to an embodiment of the present invention, a plurality of ion exchange treatments are performed. The plurality of ion exchange treatments are preferably first performing an ion exchange treatment by immersing the glass sheet to be tempered in a molten salt containing a KNO₃ molten salt and then performing an ion exchange treatment by immersing the glass sheet to be tempered in a molten salt containing a NaNO₃ molten salt. By doing so, it is possible to increase the compression stress value on the outermost surface while ensuring a large depth of layer.

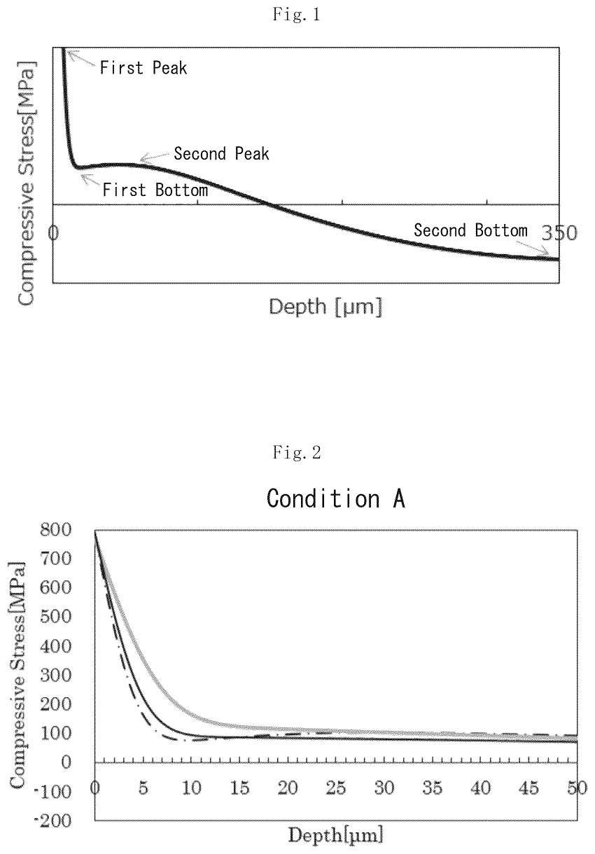

In particular, in the method for manufacturing a tempered glass sheet according to an embodiment of the present invention, it is preferable to first perform an ion exchange treatment (first ion exchange step) in which the glass sheet to be tempered is immersed in a NaNO₃ molten salt or a mixed molten salt of NaNO₃ and KNO₃, and then perform an ion exchange treatment (second ion exchange step) in which the glass sheet to be tempered is immersed in a mixed molten salt of KNO₃ and LiNO₃. Doing so can form the non-monotonic stress profile illustrated in FIG. 1, that is, a stress profile having at least a first peak, a second peak, a first bottom, and a second bottom. As a result, the probability of cover glass damage can be significantly reduced when a smart phone is dropped.

In the first ion exchange step, the Li ions contained in the glass are exchanged with the Na ions in the molten salt; when a mixed molten salt of NaNO₃ and KNO₃ is used, the Na ions contained in the glass are further exchanged with the K ions in the molten salt. Here, the ion exchange between the Li ions contained in the glass and the Na ions in the molten salt is faster and more efficient than the ion exchange between the Na ions contained in the glass and the K ions in the molten salt. In the second ion exchange step, the Na ions in the vicinity of the glass surface (a shallow region from the outermost surface to 20% of the sheet thickness) are exchanged with the Li ions in the molten salt, and in addition, the Na ions in the vicinity of the glass surface (a shallow region from the outermost surface to 20% of the sheet thickness) are exchanged with the K ions in the molten salt. That is, in the second ion exchange step, the K ions having a large ion radius can be introduced while the Na ions in the vicinity of the glass surface are removed. As a result, it is possible to increase the compression stress value on the outermost surface while maintaining a large depth of layer.

In the first ion exchange step, the temperature of the molten salt is preferably from 360 to 400° C., and the ion exchange time is preferably from 30 minutes to 6 hours. In the second ion exchange step, the temperature of the ion exchange solution is preferably from 370 to 400° C., and the ion exchange time is preferably from 15 minutes to 3 hours.

In order to form a non-monotonic stress profile, the mixed molten salt of NaNO₃ and KNO₃ used in the first ion exchange step preferably has a concentration of NaNO₃ higher than that of KNO₃, and the mixed molten salt of KNO₃ and LiNO₃ used in the second ion exchange step preferably has a concentration of KNO₃ higher than that of LiNO₃.

In the mixed molten salt of NaNO₃ and KNO₃ used in the first ion exchange step, the concentration of KNO₃ is preferably 0 mass % or greater, 0.5 mass % or greater, 1 mass % or greater, 5 mass % or greater, 7 mass % or greater, 10 mass % or greater, or 15 mass % or greater, and particularly preferably from 20 to 90 mass %. When the concentration of KNO₃ is too high, the compression stress value formed when the Li ions contained in the glass exchanges with the Na ions in the molten salt may be too small. Meanwhile, when the concentration of KNO₃ is too low, measuring stress using a surface stress meter may become difficult.

In the mixed molten salt of KNO₃ and LiNO₃ used in the second ion exchange step, the concentration of LiNO₃ is preferably more than 0 mass % and 5 mass % or less, more than 0 mass % and 3 mass % or less, or more than 0 mass % and 2 mass % or less, and particularly preferably from 0.1 to 1 mass %. When the concentration of LiNO₃ is too low, the Na ions in the vicinity of the glass surface are less likely to be removed. Meanwhile, when the concentration of LiNO₃ is too high, the compression stress value resulting from the ion exchange between the Na ions in the vicinity of the glass surface and the K ions in the molten salt may decrease too much.

### Example 1

The present invention will be described below based on Examples. Note that the following examples are merely illustrative. The present invention is not limited to the following examples in any way.

Table 1 lists glass compositions and glass properties of Examples (Samples No. 1 to 8 and No. 12) of the present invention. Table 2 lists glass compositions and glass properties of Comparative Examples (Samples No. 9 to 11) of the present invention. Note that, in the table, “N.A.” means not measured, “(Li₂O+Na₂O+K₂O)/Al₂O₃” means the molar ratio ([Li₂O]+[Na₂O]+[K₂O])/[Al₂O₃], “(Si+P+B)/((100Sn)×(Al+Li+Na+K+Mg+Ca+Sr+Ba+Zn))” means the molar ratio ([SiO₂]+[B₂O₃]+[P₂O₅]/((100×[SnO₂])×([Al₂O₃]+[Li₂O]+[Na₂O]+[K₂O]+[MgO]+[CaO]+[SrO]+[BaO]+[ZnO])).

TABLE 1

| mol % | No. 1 | No. 2 | No. 3 | No. 4 | No. 5 | No. 6 | No. 7 | No. 8 | No. 12 |
|---|---|---|---|---|---|---|---|---|---|
| SiO2 | 59.70 | 59.11 | 58.85 | 58.93 | 58.71 | 59.42 | 59.48 | 59.39 | 59.13 |
| Al2O3 | 18.71 | 18.71 | 18.66 | 18.72 | 18.73 | 18.70 | 18.68 | 18.69 | 18.86 |
| B2O3 | 0.20 | 0.20 | 0.20 | 0.40 | 0.40 | 0.40 | 0.40 | 0.40 | 0.20 |
| Li2O | 8.12 | 8.12 | 8.13 | 8.12 | 8.13 | 8.14 | 8.14 | 8.14 | 7.20 |
| Na2O | 8.17 | 8.19 | 8.20 | 8.17 | 8.15 | 8.18 | 8.15 | 8.19 | 9.12 |
| K2O | 0.19 | 0.19 | 0.47 | 0.19 | 0.46 | 0.18 | 0.18 | 0.16 | 0.47 |
| MgO | 0.50 | 0.99 | 1.00 | 1.00 | 1.00 | 0.50 | 0.52 | 0.50 | 0.50 |
| ZnO | 0.00 | 0.00 | 0.00 | 0.00 | 0.00 | 0.00 | 0.00 | 0.00 | 0.00 |
| P2O5 | 4.27 | 4.34 | 4.34 | 4.32 | 4.29 | 4.33 | 4.30 | 4.34 | 4.35 |
| SnO2 | 0.03 | 0.03 | 0.03 | 0.03 | 0.03 | 0.04 | 0.04 | 0.03 | 0.04 |
| Fe2O3 | 0.001 | 0.002 | 0.002 | 0.002 | 0.001 | 0.002 | 0.002 | 0.002 | 0.002 |
| TiO2 | 0.002 | 0.002 | 0.002 | 0.002 | 0.003 | 0.002 | 0.002 | 0.002 | 0.002 |
| Cl | 0.10 | 0.11 | 0.11 | 0.11 | 0.10 | 0.11 | 0.10 | 0.15 | 0.12 |
| R2O/Al2O3 | 0.88 | 0.88 | 0.90 | 0.88 | 0.89 | 0.88 | 0.88 | 0.88 | 0.89 |
| (Si + P + B)/((100 Sn) × | 0.64 | 0.57 | 0.57 | 0.58 | 0.58 | 0.48 | 0.40 | 0.59 | 0.43 |
| (Li + Na + K + Mg + | | | | | | | | | |
| Ca + Ba + Sr + Zn + Al)) | | | | | | | | | |
| ρ(g/cm³) | 2.4023 | 2.4068 | 2.4087 | 2.4054 | 2.4078 | 2.4011 | 2.4017 | 2.4014 | 2.4084 |
| a_{30-380° C.}(×10⁻⁷/° C.) | 74.7 | 74.5 | 76.8 | 75.1 | 76.3 | 75.1 | 75.4 | 74.9 | 78.8 |
| Ts (° C.) | 912 | 902 | 898 | 897 | 893 | 904 | 903 | 904 | 909 |
| 10^{2.5} dPa · s (° C.) | 1562 | 1554 | 1549 | 1545 | 1547 | 1564 | 1564 | 1563 | 1563 |
| TL (° C.) | N.A. | N.A. | N.A. | N.A. | N.A. | N.A. | N.A. | 1092 | 1094 |
| Log η at TL (dPa · s) | 5.2 | N.A. | N.A. | 5.1 | N.A. | N.A. | N.A. | 5.4 | 5.4 |
| Acid Resistance (HCl 5 | 25.4 | 34.4 | 39.0 | 33.2 | 37.6 | N.A. | N.A. | 27.2 | 38.4 |
| wt % 80° C. 24 h) | | | | | | | | | |
| Alkali Resistance (NaOH | N.A. | N.A. | N.A. | N.A. | N.A. | N.A. | N.A. | 1.3 | 1.2 |
| 5 wt % 80° C. 6 h) | | | | | | | | | |
| E (GPa) | N.A. | N.A. | N.A. | N.A. | N.A. | N.A. | N.A. | 75 | 75 |
| CS_{K} (MPa) | 1116 | 1121 | 1115 | 1122 | 1116 | 1094 | 1100 | 1090 | 1123 |
| DOL_ZERO_{K} (μm) | 24 | 22 | 24 | 22 | 23 | 23 | 23 | N.A. | 28 |
| CS_{Na} (MPa) | 290 | 279 | 283 | 291 | 296 | 286 | N.A. | N.A. | 275 |
| DOL_ZERO_{Na} (μm) | 132 | 129 | 121 | 122 | 121 | 126 | N.A. | N.A. | 123 |
| Bubble Formation | Good | Good | Good | Good | Good | Good | Good | Good | Good |
| Property | | | | | | | | | |

TABLE 2

| mol % | No. 9 | No. 10 | No. 11 |
|---|---|---|---|
| SiO2 | 60.18 | 60.30 | 60.83 |
| Al2O3 | 18.97 | 18.97 | 17.99 |
| B2O3 | 0.20 | 0.20 | 0.00 |
| Li2O | 7.22 | 7.22 | 8.38 |
| Na2O | 8.26 | 8.26 | 11.00 |
| K2O | 0.44 | 0.44 | 0.00 |
| MgO | 0.26 | 0.26 | 0.00 |
| ZnO | 0.00 | 0.00 | 1.14 |
| P2O5 | 4.29 | 4.29 | 0.59 |
| SnO2 | 0.05 | 0.05 | 0.04 |
| Fe2O3 | 0.002 | 0.002 | 0.001 |
| TiO2 | 0.002 | 0.002 | 0.002 |
| Cl | 0.12 | 0.01 | 0.02 |
| R2O/Al2O3 | 0.84 | 0.84 | 1.08 |
| (Si + P + B)/((100Sn) × (Li + Na + | 0.40 | 0.40 | 0.36 |
| K + Mg + Ca + Ba + Sr + Zn + Al)) | | | |
| ρ(g/cm³) | 2.4036 | N.A. | 2.4600 |
| a_{30-380° C.}(×10⁻⁷/° C.) | 74.3 | N.A. | 87.1 |
| Ts (° C.) | 910 | N.A. | N.A. |
| 10^{2.5} dPa · s (° C.) | 1575 | N.A. | 1528 |
| TL (° C.) | N.A. | N.A. | N.A. |
| Log η at TL (dPa · s) | 5.2 | N.A. | N.A. |
| Acid Resistance (HCl 5 wt % 80° C. | 19.9 | N.A. | N.A. |
| 24 h) | | | |
| Alkali Resistance (NaOH 5 wt % | 1.5 | N.A. | N.A. |
| 80° C. 6 h) | | | |
| E (GPa) | 74 | N.A. | 80 |
| CS_{K} (MPa) | 1072 | 1070 | 1165 |
| DOL_ZERO_{K} (μm) | 25 | N.A. | 17 |
| CS_{Na} (MPa) | 260 | 260 | 305 |
| DOL_ZERO_{Na} (μm) | 126 | N.A. | 119 |
| Bubble Formation Property | Good | Marginal | Marginal |

Each of the samples in the table was produced as follows. First, glass raw materials were mixed to give a glass composition presented in the table, and the mixture was melted at 1600° C. for 21 hours using a platinum pot. Then, the resulting molten glass was poured onto a carbon plate and formed into a flat plate shape, and then cooled at 3° C./min in the temperature range from the annealing point to the strain point, resulting in a glass sheet (glass sheet to be tempered). The surface of the resulting glass sheet was optically polished to give the glass sheet a sheet thickness of 1.5 mm, and then various properties were evaluated.

The density (ρ) is a value measured using the well-known Archimedes method.

The thermal expansion coefficient at from 30 to 380° C. (α_{30-380° C.}) is a value obtained by measuring an average thermal expansion coefficient using a dilatometer.

The temperature at the viscosity in high temperature of 10^{2.5} dPa·s (10^{2.5} dPa·s) is a value measured by the platinum sphere pull up method.

The softening point (Ts) is a value measured based on the method of ASTM C338.

The liquidus temperature (TL) was defined as follows. Glass powder that passed through a standard 30-mesh sieve (500 μm) and remained on a 50-mesh sieve (300 μm) was placed in a platinum boat and kept in a gradient heating furnace for 24 hours. After that, the platinum boat was taken out, and the highest temperature at which devitrification (devitrified stones) inside the glass was observed via a microscope was defined as the “liquidus temperature”. The liquidus viscosity (log η at TL) is a value obtained by measuring the viscosity at the liquidus temperature using the platinum sphere pull up method, and is expressed as a logarithm, log η.

In the acid resistance test, evaluation was carried out as follows. A glass sample with dimensions of 50×10×1.0 mm and mirror-polished on both sides was used as the sample to be measured. After being thoroughly washed with a neutral detergent and pure water, the sample to be measured was immersed for 24 hours in a 5 mass % HCl aqueous solution heated to 80° C., and the mass loss per unit surface area (mg/cm²) before and after immersion was calculated.

In the alkali resistance test, evaluation was carried out as follows. A glass sample with dimensions of 50×10×1.0 mm and mirror-polished on both sides was used as the sample to be measured. After being thoroughly washed with a neutral detergent and pure water, the sample to be measured was immersed for 6 hours in a 5 mass % NaOH aqueous solution heated to 80° C., and the mass loss per unit surface area (mg/cm²) before and after immersion was calculated.

Young's modulus (E) was calculated by the method in accordance with JIS R 1602-1995 “Elastic Modulus Test Method for Fine Ceramics”.

Next, each of the glass sheets was immersed in a KNO₃ molten salt having a temperature of 430° C. for 4 hours to undergo an ion exchange treatment, resulting in a tempered glass sheet having a compression stress layer on the surface. After the glass surface was washed, the compression stress value (CSK) and the depth of layer (DOL_ZERO_{K}) of the compression stress layer on the outermost surface were calculated from the number of interference stripes and intervals therebetween observed using a surface stress meter FSM-6000 (available from Orihara industrial Co., Ltd.). Here, DOL_ZERO_{K} is the depth at which the compression stress value becomes zero. Note that, the stress characteristics were calculated using a refractive index of 1.51 and an optical elasticity constant of 29.0 [(nm/cm)/MPa] for each sample.

In addition, each of the glass sheets was immersed in a NaNO₃ molten salt having a temperature of 380° C. for 1 hour to undergo an ion exchange treatment, resulting in a tempered glass sheet. After the glass surface was washed, the compression stress value (CS_{Na}) and the depth of layer (DOL_ZERO_{Na}) on the outermost surface were calculated from a retardation distribution curve observed using a scattered light photoelastic stress meter SLP-1000 (available from Orihara Industrial Co., Ltd.). Here, DOL_ZERO_{Na} is the depth at which the stress value becomes zero. Note that, the stress characteristics were calculated using a refractive index of 1.51 and an optical elasticity constant of 29.0 [(nm/cm)/MPa] for each sample.

In addition, each of the glass sheets was crushed into a size of from 2 to 5.6 mm and classified. Then, the temperature was raised to 1650° C., and the molten glass was subjected to High Temperature Observation (HTO). During the observation, the clarity was evaluated as “Good” when bubbles of 75 μm or larger were not observed and evaluated as “Marginal” otherwise.

Table 1 reveals the following. In Samples No. 1 to 8 and No. 12, the molar ratio ([Li₂O]+[Na₂O]+[K₂O])/[Al₂O₃] was large. As such, when a KNO₃ molten salt was used to perform an ion exchange treatment, the compression stress value of the compression stress layer (CSK) was 1090 MPa or greater, and when a NaNO₃ molten salt was further used to perform an ion exchange treatment, the compression stress value of the compression stress layer on the outermost surface (CS_{Na}) was 279 MPa or greater.

In addition, as can be seen from Table 1, in Samples No. 1 to 8 and No. 12, the molar ratio ([SiO₂]+[B₂O₃]+[P₂O₅])/((100×[SnO₂])×([Al₂O₃]+[Li₂O]+[Na₂O]+[K₂O]+[MgO]+[CaO]+[SrO]+[BaO]+[ZnO])) was 0.40 or greater, and thus the evaluation result of clarity was good.

Meanwhile, as can be seen from Table 2, in Samples No. 9 and 10, the molar ratio ([Li₂O]+[Na₂O]+[K₂O])/[Al₂O₃] was less than 0.86, and thus the compression stress value of the compression stress layer (CSK) was lower than that of the Samples of the Examples. In addition, in Sample No. 11, the molar ratio ([SiO₂]+[B₂O₃]+[P₂O₅])/((100×[SnO₂])×([Al₂O₃]+[Li₂O]+[Na₂O]+[K₂O]+[MgO]+[CaO]+[SrO]+[BaO]+[ZnO])) was less than 0.40, and thus the evaluation result of clarity was poor.

### Example 2

First, glass raw materials were mixed to give the glass compositions of Samples No. 1 and No. 6 presented in Table 1, and the mixtures were melted at 1600° C. for 21 hours using a platinum pot. Then, the resulting molten glasses were poured onto a carbon plate and formed into a flat plate shape, and then cooled at 3° C./min in the temperature range from the annealing point to the strain point, resulting in glass sheets (glass sheets to be tempered). The surfaces of the resulting glass sheets were optically polished to give the glass sheets a sheet thickness of 0.7 mm.

The resulting glass sheets to be tempered were immersed in a NaNO₃ molten salt (with the concentration of NaNO₃ being 100 mass %) having a temperature of 380° C. for 3 hours to undergo an ion exchange treatment, and then immersed in a mixed molten salt of KNO₃ and LiNO₃ (with the concentration of LiNO₃ being 2.5 mass %) having a temperature of 380° C. for 75 minutes to undergo an ion exchange treatment. Further, the surfaces of the resulting tempered glass sheets were washed, and then the stress profiles of the tempered glass sheets were measured using a scattered light photoelastic stress meter SLP-1000 (available from Orihara Industrial Co., Ltd.) and a surface stress meter FSM-6000 (available from Orihara industrial Co., Ltd.). The results indicated that both tempered glass sheets had a non-monotonic stress profile similar to that of FIG. 1, that is, a stress profile having a first peak, a second peak, a first bottom, and a second bottom.

### Example 3

First, glass raw materials were mixed to give the glass compositions of Samples No. 6, No. 9, and No. 12 presented in Table 1, and the mixtures were melted at 1600° C. for 21 hours using a platinum pot. Then, the resulting molten glasses were poured onto a carbon plate and formed into a flat plate shape, and then cooled at 3° C./min in a temperature range from the annealing point to the strain point, resulting in glass sheets (glass sheets to be tempered). The surfaces of the resulting glass sheets were optically polished to give the glass sheets a sheet thickness of 0.8 mm.

The resulting glass sheets to be tempered were immersed in a mixed molten salt of KNO₃ and NaNO₃ (with the concentration of NaNO₃ being 60 mass %) having a temperature of 380° C. for 3 hours to undergo an ion exchange treatment, and then immersed in a mixed molten salt of KNO₃ and LiNO₃ (with the concentration of LiNO₃ being 1.0 mass %) having a temperature of 380° C. for 30 minutes to undergo an ion exchange treatment (Condition A). Further, the surfaces of the resulting tempered glass sheets were washed, and then the stress profiles of the tempered glass sheets were measured using a scattered light photoelastic stress meter SLP-1000 (available from Orihara Industrial Co., Ltd.) and a surface stress meter FSM-6000 (available from Orihara industrial Co., Ltd.). The results indicated that all three tempered glass sheets had the non-monotonic stress profile illustrated in FIG. 2.

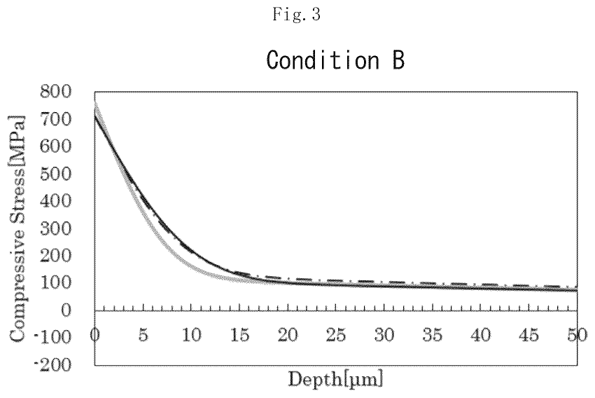

The resulting glass sheets to be tempered were immersed in a mixed molten salt of KNO₃ and NaNO₃ (with the concentration of NaNO₃ being 60 mass %) having a temperature of 380° C. for 3 hours to undergo an ion exchange treatment, and then immersed in a mixed molten salt of KNO₃, NaNO₃, and LiNO₃ (with the concentration of NaNO₃ being 4.0 mass % and the concentration of LiNO₃ being 1.0 mass %) having a temperature of 380° C. for 45 minutes to undergo an ion exchange treatment (Condition B). Further, the surfaces of the resulting tempered glass sheets were washed, and then the stress profiles of the tempered glass sheets were measured using a scattered light photoelastic stress meter SLP-1000 (available from Orihara Industrial Co., Ltd.) and a surface stress meter FSM-6000 (available from Orihara industrial Co., Ltd.). The results indicated that all three tempered glass sheets had the non-monotonic stress profile illustrated in FIG. 3.

Table 3 lists the compression stress value on the outermost surface (CS), the depth of layer (DOC), the compression stress value at the depth of 2.5 μm (CS_{2.5}), and the average value of the compression stress at the depth of from 30 to 45 μm (CS₃₀₋₄₅) of the stress profile of each sample.

TABLE 3

| | Sample | | | | | |
|---|---|---|---|---|---|---|
| | No. 6 | No. 9 | No. 12 | No. 6 | No. 9 | No. 12 |
| Ion Exchange | A | A | A | B | B | B |
| Conditions | | | | | | |
| CS [MPa] | 787 | 790 | 772 | 711 | 711 | 758 |
| DOC [μm] | 165 | 167 | 146 | 154 | 155 | 153 |
| CS_{2.5} [MPa] | 395 | 450 | 542 | 548 | 557 | 540 |
| CS₃₀₋₄₅ [MPa] | 102 | 77 | 96 | 97 | 81 | 85 |

FIG. 3, FIG. 4, and Table 3 suggest the following. After undergoing ion exchange under Condition A and Condition B, Sample No. 6 and Sample No. 12 had a stress profile having a CS_{2.5} of 350 MPa or greater and a CS₃₀₋₄₅ of 85 MPa or greater. As such, Sample No. 6 and Sample No. 12 are considered to have high bending strength and high drop resistance strength. Meanwhile, after undergoing ion exchange under Condition A and Condition B, Sample No. 9 had a stress profile having a CS₃₀-45 of less than 85 MPa. As such, Sample No. 9 is considered to have low drop resistance strength.

### INDUSTRIAL APPLICABILITY

The tempered glass sheet according to an embodiment of the present invention is suitable as a cover glass for a touch panel display, such as that of a mobile phone, a digital camera, or a personal digital assistant (PDA). In addition to those applications, the tempered glass sheet according to an embodiment of the present invention is expected to be applied to an application requiring high mechanical strength, such as window glass, a substrate for a magnetic disk, a substrate for a flat panel display, a substrate for a flexible display, cover glass for a solar cell, cover glass for a solid-state image sensor, and in-vehicle cover glass.

1. A tempered glass sheet comprising a compression stress layer on a surface and a glass composition containing from 40 to 80 mol % of SiO₂, from 6 to 25 mol % of Al₂O₃, from 0 to 10 mol % of B₂O₃, from 3 to 15 mol % of Li₂O, from 1 to 21 mol % of Na₂O, from 0 to 10 mol % of K₂O, from 0 to 10 mol % of MgO, from 0 to 10 mol % of ZnO, from 0 to 15 mol % of P₂O₅, and from 0.001 to 0.30 mol % of SnO₂, wherein ([Li₂O]+[Na₂O]+[K₂O])/[Al₂O₃] is greater than or equal to 0.86, and ([SiO₂]+[B₂O₃]+[P₂O₅])/((100×[SnO₂])×([Al₂O₃]+[Li₂O]+[Na₂O]+[K₂O]+[MgO]+[CaO]+[SrO]+[BaO]+[ZnO])) is greater than or equal to 0.40.

2. The tempered glass sheet according to claim 1, wherein a content of B₂O₃ is from 0.1 to 3 mol %.

3. The tempered glass sheet according to claim 1, wherein a content of SnO₂ is 0.045 mol % or less.

4. The tempered glass sheet according to claim 1, wherein a content of Cl is from 0.02 to 0.3 mol %.

5. A tempered glass sheet comprising a compression stress layer on a surface and a glass composition containing from 40 to 80 mol % of SiO₂, from 6 to 25 mol % of Al₂O₃, from 0 to 10 mol % of B₂O₃, from 3 to 15 mol % of Li₂O, from 1 to 21 mol % of Na₂O, from 0 to 10 mol % of K₂O, from 0 to 10 mol % of MgO, from 0 to 10 mol % of ZnO, from 0 to 15 mol % of P₂O₅, from 0.001 to 0.045 mol % of SnO₂, and from 0.02 to 0.3 mol % of Cl, wherein ([Li₂O]+[Na₂O]+[K₂O])/[Al₂O₃] is greater than or equal to 0.86.

6. A tempered glass sheet comprising a compression stress layer on a surface and a glass composition containing from 40 to 80 mol % of SiO₂, from 6 to 25 mol % of Al₂O₃, from 0.1 to 3 mol % of B₂O₃, from 3 to 15 mol % of Li₂O, from 1 to 21 mol % of Na₂O, from 0 to 10 mol % of K₂O, from 0 to 10 mol % of MgO, from 0 to 10 mol % of ZnO, from 0 to 15 mol % of P₂O₅, from 0.001 to 0.30 mol % of SnO₂, and from 0.02 to 0.3 mol % of Cl, wherein ([Li₂O]+[Na₂O]+[K₂O])/[Al₂O₃] is greater than or equal to 0.86, and ([SiO₂]+[B₂O₃]+[P₂O₅])/((100×[SnO₂])×([Al₂O₃]+[Li₂O]+[Na₂O]+[K₂O]+[MgO]+[CaO]+[SrO]+[BaO]+[ZnO])) is greater than or equal to 0.40.

7. The tempered glass sheet according to claim 1, wherein a content of P₂O₅ is 2.5 mol % or greater.

8. The tempered glass sheet according to claim 1, wherein a content of Fe₂O₃ is from 0.001 to 0.1 mol %.

9. The tempered glass sheet according to claim 1, wherein a content of TiO₂ is from 0.001 to 0.1 mol %.

10. The tempered glass sheet according to claim 1, wherein a compression stress value on an outermost surface of the compression stress layer is from 200 to 1200 MPa.

11. The tempered glass sheet according to claim 1, wherein a depth of layer of the compression stress layer is from 50 to 200 μm.

12. The tempered glass sheet according to claim 1, wherein a compression stress value at the depth of 2.5 μm is 350 MPa or greater.

13. The tempered glass sheet according to claim 1, wherein an average compression stress value at the depth of from 30 to 45 μm is 85 MPa or greater.

14. The tempered glass sheet according to claim 1, wherein a temperature at a viscosity in high temperature of 10^{2.5} dPa·s is less than 1650° C.

15. The tempered glass sheet according to claim 1, comprising an overflow-joined surface at a central portion in a sheet thickness direction.

16. The tempered glass sheet according to claim 1, which is for use as a cover glass for a touch panel display.

17. The tempered glass sheet according to claim 1, wherein a stress profile in a thickness direction includes at least a first peak, a second peak, a first bottom, and a second bottom.

18. A method of manufacturing a tempered glass sheet, the method comprising a preparation step and an ion exchange step, the preparation step comprising preparing a glass sheet to be tempered comprising a glass composition containing from 40 to 80 mol % of SiO₂, from 6 to 25 mol % of Al₂O₃, from 0 to 10 mol % of B₂O₃, from 3 to 15 mol % of Li₂O, from 1 to 21 mol % of Na₂O, from 0 to 10 mol % of K₂O, from 0 to 10 mol % of MgO, from 0 to 10 mol % of ZnO, from 0 to 15 mol % of P₂O₅, and from 0.001 to 0.30 mol % of SnO₂, wherein ([Li₂O]+[Na₂O]+[K₂O])/[Al₂O₃] is greater than or equal to 0.86, and ([SiO₂]+[B₂O₃]+[P₂O₅])/((100×[SnO₂])×([Al₂O₃]+[Li₂O]+[Na₂O]+[K₂O]+[MgO]+[CaO]+[SrO]+[BaO]+[ZnO])) is greater than or equal to 0.40, the ion exchange step comprising, by subjecting the glass sheet to be tempered to a plurality of ion exchange treatments, obtaining a tempered glass sheet comprising a compression stress layer on a surface.

19. A glass sheet to be tempered, which is an ion-exchangeable glass sheet to be tempered, comprising a glass composition containing from 40 to 80 mol % of SiO₂, from 6 to 25 mol % of Al₂O₃, from 0 to 10 mol % of B₂O₃, from 3 to 15 mol % of Li₂O, from 1 to 21 mol % of Na₂O, from 0 to 10 mol % of K₂O, from 0 to 10 mol % of MgO, from 0 to 10 mol % of ZnO, from 0 to 15 mol % of P₂O₅, and from 0.001 to 0.30 mol % of SnO₂, wherein ([Li₂O]+[Na₂O]+[K₂O])/[Al₂O₃] is greater than or equal to 0.86, and ([SiO₂]+[B₂O₃]+[P₂O₅])/((100×[SnO₂])×([Al₂O₃]+[Li₂O]+[Na₂O]+[K₂O]+[MgO]+[CaO]+[SrO]+[BaO]+[ZnO])) is greater than or equal to 0.40.

20. A glass sheet to be tempered, which is an ion-exchangeable glass sheet to be tempered, comprising a glass composition containing from 40 to 80 mol % of SiO₂, from 6 to 25 mol % of Al₂O₃, from 0 to 10 mol % of B₂O₃, from 3 to 15 mol % of Li₂O, from 1 to 21 mol % of Na₂O, from 0 to 10 mol % of K₂O, from 0 to 10 mol % of MgO, from 0 to 10 mol % of ZnO, from 0 to 15 mol % of P₂O₅, from 0.001 to 0.045 mol % of SnO₂, and from 0.02 to 0.3 mol % of Cl, wherein ([Li₂O]+[Na₂O]+[K₂O])/[Al₂O₃] is greater than or equal to 0.86, and ([SiO₂]+[B₂O₃]+[P₂O₅])/((100×[SnO₂])×([Al₂O₃]+[Li₂O]+[Na₂O]+[K₂O]+[MgO]+[CaO]+[SrO]+[BaO]+[ZnO])) is greater than or equal to 0.40.

21. A glass sheet to be tempered, which is an ion-exchangeable glass sheet to be tempered, comprising a glass composition containing from 40 to 80 mol % of SiO₂, from 6 to 25 mol % of Al₂O₃, from 0.1 to 3 mol % of B₂O₃, from 3 to 15 mol % of Li₂O, from 1 to 21 mol % of Na₂O, from 0 to 10 mol % of K₂O, from 0 to 10 mol % of MgO, from 0 to 10 mol % of ZnO, from 0 to 15 mol % of P₂O₅, from 0.001 to 0.30 mol % of SnO₂, and from 0.02 to 0.3 mol % of Cl, wherein ([Li₂O]+[Na₂O]+[K₂O])/[Al₂O₃] is greater than or equal to 0.86, and ([SiO₂]+[B₂O₃]+[P₂O₅])/((100×[SnO₂])×([Al₂O₃]+[Li₂O]+[Na₂O]+[K₂O]+[MgO]+[CaO]+[SrO]+[BaO]+[ZnO])) is greater than or equal to 0.40.
